(19) United States
(12) Patent Application Publication
(10) Pub. No.: US 2026/0158488 A1
(43) Pub. Date: Jun. 11, 2026

(54) LIGHT BOX SYSTEM FOR OPTICAL ASSAY INTERROGATION

(71) Applicant: Becton, Dickinson and Company, Franklin Lakes, NJ (US)

(72) Inventors: Vivian Wang, Tustin, CA (US); Michael August Tycon, Scottsdale, AZ (US); Robert A. Fulcher, Hillsborough, NC (US); William James Eldridge, Durham, NC (US); James R. Petisce, Westford, MA (US); Jingyun Zhang, Freeland, MD (US); Aaron Alexander Rowe, North Hollywood, CA (US); Callum Leneman, San Francisco, CA (US); Daniel Randall, Huntersville, NC (US); Grace Annese, Pittsford, NY (US)

(21) Appl. No.: 19/180,669

(22) Filed: Apr. 16, 2025

Related U.S. Application Data
(63) Continuation of application No. PCT/US2023/076808, filed on Oct. 13, 2023.
(60) Provisional application No. 63/379,876, filed on Oct. 17, 2022.
(60) Provisional application No. 63/519,808, filed on Aug. 15, 2023.

(51) Int. Cl. B01L 3/00; G01N 21/78; G01N 21/84

(52) U.S. Cl. CPC B01L 3/5023; G01N 21/78; G01N 21/8483; B01L 2300/0654; B01L 2300/0825; G01N 2201/0221; G01N 2201/06

(57) ABSTRACT

Aspects of the present disclosure relate to light boxes capable of improving imaging of point-of-care test devices. In one aspect, a disposable light box can also function as packaging for a test device. In one aspect, a light box includes integrated light sources. In one aspect, a layer of PTFE can be applied to an interior surface of a light box to improve light distribution to a top surface of the test device received inside the light box.

### CROSS-REFERENCE TO RELATED APPLICATIONS

This application is a continuation of PCT International Application No. PCT/US2023/076808, filed on Oct. 13, 2023, designating the United States of America and published in the English language, which claims the benefit of U.S. Provisional Application No. 63/379,876, filed Oct. 17, 2022, and U.S. Provisional Application No. 63/519,808, filed Aug. 15, 2023, each of which are hereby incorporated by reference in their entirety.

### BACKGROUND

### Field

The present disclosure relates to analyte testing, and more particularly to point-of-care diagnostic testing and imaging.

### Description of the Related Art

Test analysis information may be obtained from images of testing devices such as lateral flow assays or other cartridge-based tests. Determination of analysis information based on image analysis may be susceptible to error based on color management, alignment, image warping, and other sources of error within the captured images. For example, such methods may be susceptible to reading errors such as false negative results due to degraded image quality (e.g., high noise level, poor illumination, poor focus, significant motion blur, etc.) and/or algorithmic errors (e.g., inadequate homography, inadequate normalization, etc.).

In addition, many optical diagnostic tests, such as those using colorimetric or reflectometric signal interrogation, rely on relatively diffuse and uniform illumination to enable accurate signal readings. As smart phone cameras begin to be used to read test devices, ambient room light is still responsible for illumination. Analysis of images captured by a camera of a smartphone or other mobile device may be especially susceptible to error.

### SUMMARY

To limit the occurrence of errors in image-based test analysis systems, imaging systems for test analysis are usually operated in very controlled environments and carefully calibrated and normalized. Controlling imaging environments may present challenges for point-of-care testing, where users may not have the equipment necessary to make consistent, high-quality images. Light boxes according to the present disclosure may ensure consistent and reproducible imaging conditions.

In one non-limiting example, a light box for imaging a diagnostic test device is provided. The light box includes a box structure, the box structure configured to package the diagnostic test device before use of the diagnostic test device, the box structure including: a plurality of side walls and an upper surface defining an interior volume; and at least one aperture in the upper surface configured to allow a mobile device to image the diagnostic test device through the aperture while the diagnostic test device is disposed within the interior volume.

The light box can include a carriage sized and shaped to fit within the interior volume of the light box and configured to facilitate positioning of the diagnostic test device within the light box for imaging by the mobile device. The carriage can include an adhesive configured to secure the diagnostic test device to the carriage. The carriage can include at least one alignment marking identifying a location for placement of the diagnostic test device on the carriage.

The light box can include at least one aperture comprises a transparent window and wherein the mobile device at least partially rests on the transparent window. The upper surface of the light box can be configured to support the mobile device while the mobile device images the diagnostic test device through the aperture. The light box can include a polytetrafluoroethylene (PTFE) polymer coating on at least one interior surface of the box structure. The at least one aperture can be sized and shaped to simultaneously accommodate image capture by a camera of the mobile device and illumination of the diagnostic test device by a light emitter of the mobile device. The at least one aperture of the light box can include a first aperture sized and shaped to accommodate simultaneous illumination and imaging of the diagnostic test device by a first model of mobile device having a first camera and flash configuration, and a second aperture sized and shaped to accommodate simultaneous illumination and imaging of the diagnostic test device by a second model of mobile device having a second camera and flash configuration. The upper surface of the light box can include at least one alignment marking identifying a location for placement of the mobile device on the upper surface. The light box can further include a light diffuser positioned above or below the aperture. The light diffuser can be affixed to a bottom surface of a transparent window at least partially covering the aperture. The light box can include a removable protective covering overlying at least a portion of the aperture. The light box can be configured to be foldable between a shipping configuration and an imaging configuration, the shipping configuration having a first height and the imaging configuration having a second height greater than the first height, the second height corresponding to an imaging focal distance of the mobile device. The upper surface of the light box can be recessed from a top surface of the box structure, the upper surface configured to receive and hold the mobile device.

In another non-limiting example, a method of imaging a test device is provided. The method can include unfolding a light box from a shipping configuration to an imaging configuration, wherein the light box comprises an aperture; placing a test device within the light box in the imaging configuration; and imaging, using a mobile device, the test device.

The method can include removing a cover from the aperture of the light box. The method can include aligning a camera of the mobile device with the aperture. The method can include aligning the test device with the aperture. The method can include placing the mobile device on a surface of the light box. Placing the test device within the light box can include placing the test device on a carriage and inserting the carriage into the light box. The method can further include adhering the test device to the carriage. In the imaging configuration, the light box can have a height greater than or equal to a focal distance of the mobile device.

In yet another non-limiting example, a light box for imaging a diagnostic test device is provided. The light box can include a box structure, the box structure comprising at least one aperture configured to allow a mobile device to image the diagnostic test device from a distance; and a plurality of light sources positioned within an interior volume of the box structure.

The light sources can include a plurality of LEDs. The light sources can include one or more strips of LEDs. The plurality of LEDs can include one or more first LEDs configured to emit a first set of wavelengths and one or more second LEDs configured to emit a second set of wavelengths different from the first set of wavelengths. The plurality of LEDs comprise a first plurality of LEDs disposed along a first interior side of the light box, and a second plurality of LEDs disposed along a second interior side of the light box opposite the first interior side.

The light box can further include a third plurality of LEDs disposed along a third interior side of the light box and a fourth plurality of LEDs disposed along a fourth interior side of the light box.

The light box can include a diffuser configured to diffuse light from the light sources within the light box. The diffuser can include a tray shaped and sized to receive the diagnostic test device in a position aligned with an imaging area. The tray can include a frosted plastic. The tray can include a thermoformed plastic or a 3D-printed plastic.

The plurality of LEDs can be positioned to face downward at an angle of between 15° and 85° relative to vertical. The plurality of LEDs can be positioned to face 45° downward relative to vertical. A spacing between adjacent LEDs of the plurality of LEDs can be approximately 1 centimeter. The box structure can include a plurality of side walls and an upper surface defining the interior volume. The at least one aperture can be provided in the upper surface and configured to allow the mobile device to image the diagnostic test device through the at least one aperture while the diagnostic test device is disposed within the interior volume. The box structure can include a base and a lid, and wherein the at least one aperture is provided within an upper surface of the lid. The box structure can be configured to receive the diagnostic test device into the base when the lid is removed from the box structure. The box structure can be configured to receive the diagnostic test device through an opening in a side wall of the box structure.

In yet another non-limiting example, a light box for imaging a diagnostic test device is provided. The light box includes: a box structure, the box structure configured to unfold from a shipping configuration to an imaging configuration for use with the diagnostic test device, the box structure comprising: a plurality of side walls and an upper surface defining an interior volume; and at least one aperture in the upper surface configured to allow a mobile device to image the diagnostic test device through the aperture while the diagnostic test device is disposed within the interior volume.

The light box of claim can include a carriage sized and shaped to fit within the interior volume of the light box and configured to facilitate positioning of the diagnostic test device within the light box for imaging by the mobile device. The carriage can include an adhesive configured to secure the diagnostic test device to the carriage. The carriage can include at least one alignment marking identifying a location for placement of the diagnostic test device on the carriage. The at least one aperture can include a transparent window, and the mobile device can at least partially rest on the transparent window. The upper surface of the light box can be configured to support the mobile device while the mobile device images the diagnostic test device through the aperture. The light box can further include a polytetrafluoroethylene (PTFE) polymer coating on at least one interior surface of the box structure. The at least one aperture can be sized and shaped to simultaneously accommodate image capture by a camera of the mobile device and illumination of the diagnostic test device by a light emitter of the mobile device. The at least one aperture can include a first aperture sized and shaped to accommodate simultaneous illumination and imaging of the diagnostic test device by a first model of mobile device having a first camera and flash configuration, and a second aperture sized and shaped to accommodate simultaneous illumination and imaging of the diagnostic test device by a second model of mobile device having a second camera and flash configuration. The upper surface of the light box can include at least one alignment marking identifying a location for placement of the mobile device on the upper surface. The light box can include a light diffuser positioned above or below the aperture. The light diffuser is affixed to a bottom surface of a transparent window at least partially covering the aperture. The light box can further include a removable protective covering overlying at least a portion of the aperture. The shipping configuration can include a first height and the imaging configuration having a second height greater than the first height, the second height corresponding to an imaging focal distance of the mobile device. The upper surface of the light box can be recessed from a top surface of the box structure, the upper surface configured to receive and hold the mobile device.

In any of the non-limiting examples, the box structure can be reusable.

In any of the non-limiting examples, the box structure can be disposable.

In any of the non-limiting examples, the diagnostic test device can be disposed within the interior volume of the light box.

In any of the non-limiting examples, the light box can be a shipping container for the diagnostic test device.

### BRIEF DESCRIPTION OF THE DRAWINGS

Features, aspects, and advantages of embodiments of the present disclosure will now be described in connection with various implementations, with reference to the accompanying drawings. The illustrated implementations are merely examples and are not intended to be limiting.

FIGS. 1A-1B illustrates an example disposable light box in accordance with the present disclosure including two windows for interfacing with different models of mobile devices.

FIG. 1C illustrates a removable carriage of the example disposable light box illustrated in FIGS. 1A-1B.

FIGS. 1D-1E illustrate exemplary mobile devices that may be used with a disposable light box.

FIG. 2 illustrates an example disposable light box with a mobile device positioned for imaging a test cartridge.

FIG. 3 illustrates a perspective view of an example light box with integrated light sources and a mobile device positioned for imaging a test cartridge.

FIG. 4A illustrates a cross-sectional view of an example light box including a tray for positioning light sources.

FIG. 4B illustrates a top-down view of an example light box.

FIG. 4C illustrates views of an example light box, indicating positioning of light sources within the light box.

FIG. 5 illustrates an example light box with integrated light sources.

FIG. 6 plots light intensity along the bottom surface of an example light box for three different distances between light source strips and at two light source intensities.

FIG. 7 plots light intensity along the bottom surface of an example light box for a 2-edge light source configuration and for a 4-edge light source configuration.

FIG. 8A illustrates an example light box having a diffuser tray.

FIG. 8B plots light intensity along the bottom surface of an example light box with a diffuser tray for a 2-edge light source configuration and for a 4-edge light source configuration.

FIG. 9 illustrates an example light box with a 4-edge light source configuration.

FIG. 10 illustrates an example diffuser tray.

FIGS. 11A-11F illustrate an example diffuser tray with attached light sources outside of and inside of a light box.

FIG. 12A schematically illustrates Lambertian reflectance.

FIG. 12B plots transmittance, absorption, and reflectance of sintered polytetrafluoroethylene (PTFE) across light wavelengths from 250 nm to 500 nm.

FIG. 13 plots percent reflectivity of sintered PTFE as a function of median pore diameter.

FIG. 14A illustrates a top view of an example light box with a window interfacing a smartphone positioned for imaging a test cartridge in the light box and illuminated by the smartphone's built-in flash LED.

FIG. 14B shows an image of the test cartridge taken in the example light box of FIG. 14A with an interior surface covered by white paper, and a plot showing an illumination profile along the major axis of the rectangle depicted below the image.

FIG. 14C shows an image of the test cartridge taken in the example light box of FIG. 14A with an interior surface covered by sintered PTFE, and a plot showing an illumination profile along the major axis of the rectangle depicted below the image.

FIGS. 15A-15C illustrate views of an example light box including a sintered PTFE layer on an interior surface.

### DETAILED DESCRIPTION

Embodiments of the present disclosure relate to systems and techniques for detection of analytes of interest that may be present in biological or non-biological samples such as fluids. Analytes of interest may include any detectable substances such as but not limited to antibodies, proteins, haptens, nucleic acids, amplicons, hormones, and hazardous or non-hazardous drugs or contaminants such as antineoplastic drugs used in the treatment of cancer. Throughout this disclosure, example systems, devices, and methods will be described with reference to collection, testing, and detection of analytes such as those relevant for diagnostic testing related to infectious diseases, but it will be understood that the present technology can be used to collect, test, and detect any particle, molecule, or analyte of interest. Test strips, cartridges, and devices as described herein may be configured for performance of diagnostic and/or non-diagnostic tests. In some embodiments, embodiments of the present disclosure can be implemented in conjunction with systems such as the BD Veritor System for Rapid Detection of SARS CoV-2, the BD Veritor System for Rapid Detection of Flu A+B, the BD Veritor System for Rapid Detection of Respiratory Syncytial Virus (RSV), the BD Veritor System for Rapid Detection of Group A Strep, the BD Veritor system, the BD Veritor Plus system, and/or components or operations thereof.

Light boxes may ensure consistent and reproducible imaging conditions. Ensuring consistency of imaging conditions may be desirable for imaging point-of-care test strips, cartridges, and/or devices. As mobile devices, such as mobile phones, increasingly include high-quality cameras, imaging of point-of-care assays can be conducted using such mobile devices. Disclosed herein are light boxes that can be used with mobile devices to improve assay imaging. Also disclosed herein are light boxes that can ship with test strips, cartridges, and/or devices. Also disclosed herein are light boxes that may be disposed after one or a few uses. Also disclosed herein are light boxes, usable with mobile devices, that include integrated light sources. Also disclosed herein are light boxes usable with mobile devices including components for diffusing light emitted by those light sources. Additionally, disclosed herein is a sintered PTFE coating that may be used in light boxes generally but may be particularly useful for any of the light boxes disclosed herein, such as to help create diffuse lighting conditions for imaging.

Use of the integrated camera of mobile devices, for example smart phones, as a reader for optical diagnostic test assays may be desirable, as such cameras are commonly available and produce increasingly high-quality images. Many approaches rely on the user to manually align the mobile device camera (e.g., by holding the mobile device above the test device) and the test device in the lateral and axial direction to capture the correct region of interest at the correct focal distance. But, in such approaches, ambient lighting may be poorly-controlled, and can interfere with optical signal acquisition from the test device.

Illumination with ambient light is highly variable in intensity, spectral profile, and does not prevent shadowing or illumination artifacts. To improve the utility of the mobile device, for example a smart phone, an on-board light source of the mobile device, such as a flash LED can be used to provide a consistent and controllable illumination source. However, it may be desirable to make the light from this source diffuse in some embodiments to illuminate the test device without shadowing, glare, illumination artifacts, or other conditions that may cause poor imaging. Incorporation of a low-profile light diffuser integrated into a light box may allow the interfaced mobile device to act as both a light source and an image acquisition module.

Certain existing devices clip onto a smartphone, covering the camera and flash to enhance the smartphone's ability to read a test device (which can include a diagnostic assay). Such devices are limited in their compatibility with smartphone models, however, and may fit only certain shapes and sizes of smartphone. Further, certain existing devices use a single point source of light. Such devices may require a factory calibration. Certain existing devices do not include diffusers for even distribution of light. Single-point light sources and a lack of diffusers may result in a lighting environment with aggressive lighting gradients, unsuited for imaging a test device.

Further, correct spatial alignment of test devices with the camera is desirable to ensure the region of interest is captured and to maintain the proper focal distance between the camera and the test device.

Devices in accordance with the present disclosure may reduce the alignment difficulties and may standardize the illumination conditions, as well as minimize shadowing effects. Disposable light boxes as disclosed herein can incorporate the alignment markers, test device holders, and appropriate dimensions into a low-cost light box that may also serve as product packaging. Thus, cost is reduced and the need for companion accessories is reduced or eliminated.

### Light Box

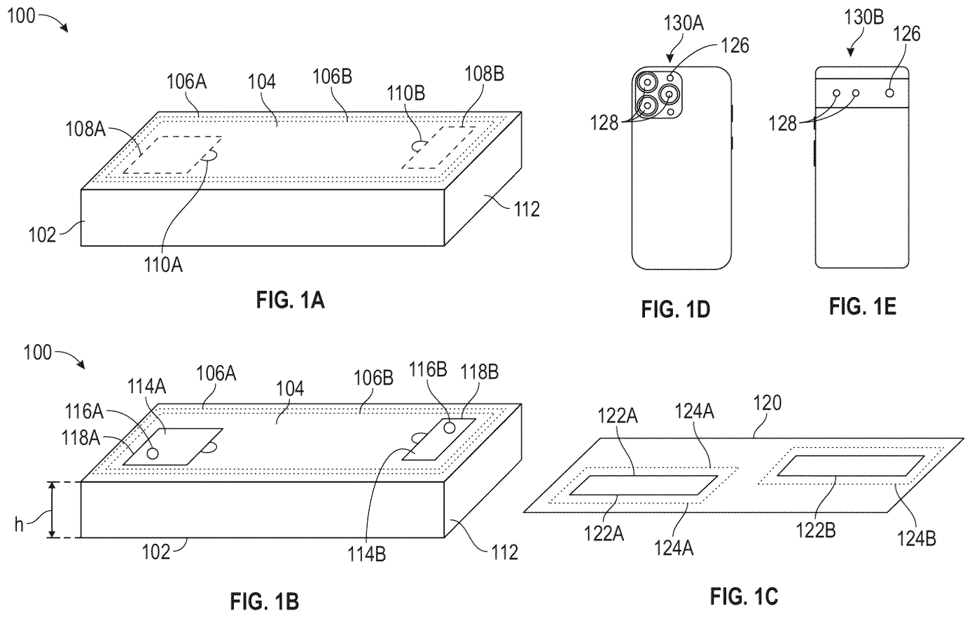

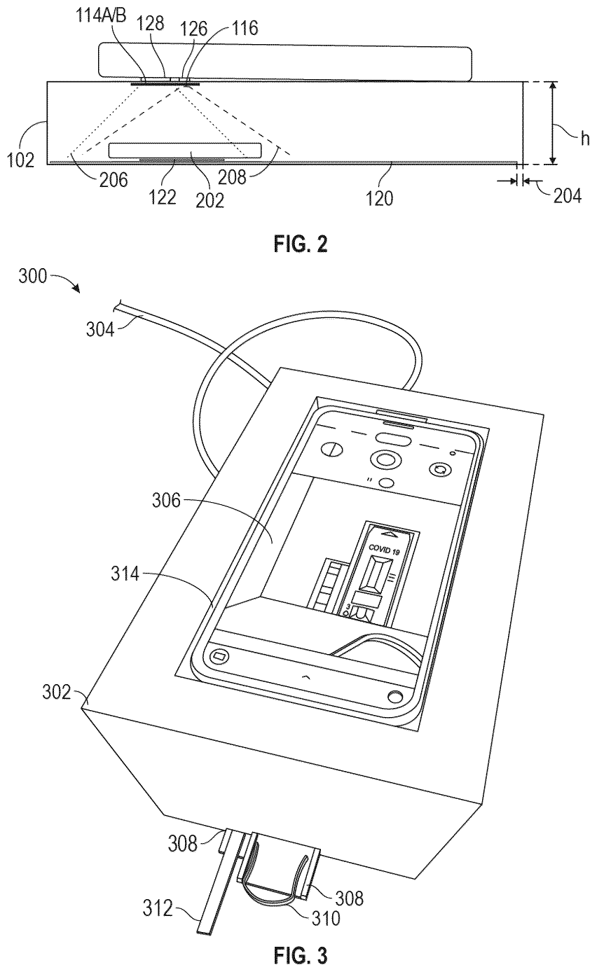

In one aspect, the present disclosure relates to a box that physically interfaces a mobile device (e.g., a smart phone, a tablet, or other mobile device capable of capturing images) to a point-of-care assay for signal interrogation and image capture as shown in FIGS. 1A-1C and 2. FIGS. 1A-1B show the light box 100. FIG. 1C shows a view of a carriage that can be inserted into the light box 100. FIGS. 1D-1E depict example mobile devices that can be used with the light box 100. The light box 100 includes a box structure 102, a surface 104, mobile device placement markings 106A and 106B, removable covers 108A and 108B, pull tabs 110A and 110B, a panel 112, windows 114A and 114B, diffusers 116A and 116B, and apertures 118A and 118B. The light box may also include a test cartridge carriage 120. The test cartridge carriage 120 can include adhesive pads 122A and 122B. FIG. 1A illustrates the light box 100 in an initial configuration where the removable covers 108A and 108B have not been removed, whereas FIG. 1B illustrates the light box 100 in a configuration where the removable covers 108A and 108B have been removed to expose the apertures 118A and 118B with windows 114A and 114B and the diffusers 116A and 116B.

The light box 100 can include light diffuser 116A that can spread out and/or diffuse the concentrated illumination from a mobile device light source 126, for example a flash LED, of mobile devices 130A. The light box 100 can include an aperture 118A including transparent window 114A to enable image capture. The light box 100 can include light diffuser 116B that can spread out and/or diffuse the concentrated illumination from a mobile device light source 126, for example a flash LED, of mobile devices 130B. The light box 100 can include an aperture 118B including transparent window 114B to enable image capture. The transparent window 114A may be protected by a removable cover 108A of the box 100. The transparent window 114B may be protected by a removable cover 108B of the box 100. The removable cover 108A may include a pull tab 110A. The removable cover 108B may include a pull tab 110B. The mobile device placement markings 106A and 106B on the upper surface 104 may be provided to allow the user to correctly position a specific model of mobile device 130A or 130B, ensuring alignment of the mobile device camera(s) 128 and light sources 126 with the integrated transparent window 114A or 114B and the light diffuser 116A or 116B. The mobile device placement markings 106A, the removable cover 108A, the pull tab 110A, the window 114A, the diffuser 116A, and the aperture 118A can be used with the mobile device 130A. The mobile device placement markings 106B, the removable cover 108B, the pull tab 110B, the window 114B, the diffuser 116B, and the aperture 118B can be used with the mobile device 130B.

A removable test cartridge carriage 120 can be included within the box 100. The carriage 120 can be removed or inserted through the panel 112, which may be opened or closed. The test cartridge carriage 120 may include test device alignment markings 124A and 124B for correct test cartridge placement on the carriage 120 depending on the specific model of mobile device. Adhesive strips 122A and 122B on the carriage can further be provided to immobilize a test strip, cartridge, and/or test device relative to the carriage 120. The adhesive pad 122A and the test device alignment markings 124A are for use with mobile device 130A. The adhesive pad 122B and the test device alignment markings 124B are for use with mobile device 130B.

### Overview of the Light Box

In some embodiments, the light box 100 may be a disposable light box. In some embodiments, the light box 100 may act as both a product packaging for a test device and a structure for a low-cost light box. In some embodiments, the light box 100 may act as both a shipping container of a test device and a structure for a low-cost light box. The box 100 may be disposable and/or may be reusable for analysis of multiple tests. In some embodiments, the box 100 may be a flat-fold box that a user can fold out to an assembled configuration (also referred to herein as an “imaging configuration”). In such embodiments, the flat-fold box may be packaged in a shipping box and/or shipping container with the test device. When in the assembled configuration, the box 100 can support the weight of a mobile device 130A and/or 130B placed on the upper surface 104 of the box 100. The box 100 may include adhesive strips to allow a user to secure the box 100 in the assembled configuration. In some embodiments, adhesive strips may be positioned by and/or on corners and/or edges of the box 100 when assembled.

An aperture 118A and/or 118B and transparent window 114A and/or 114B of the box 100 can permit the mobile device camera 128 to record images of a test device 202 when the test device 202 is positioned on the test cartridge carriage 120 and the test cartridge carriage 120 is inserted in the light box 100. The aperture 118A and/or 118B, transparent window 114A and/or 114B, and/or diffusers 116A and/or 116B may be positioned, sized, and shaped to allow simultaneous image capture by the camera 128 and illumination by the light source 126. When positioned on the upper surface 104, the mobile device 130A and/or 130B may at least partially rest on the transparent window 114A and/or 114B. The transparent windows 114A, 114B of the box may respectively include light diffusers 116A, 116B (also referred to herein as a “diffuser”). A mobile device 130, for example a smart phone, can provide the light source 126, such as a flash LED or other light source of the mobile device 130, to interrogate a test device, which may be an optical assay, such as but not limited to a lateral flow assay, colorimetric assay, and/or a reflectance-based assay. To provide uniform illumination of the test device, integrated “low-profile” light diffusers 116A, 116B may be incorporated to diffuse light emanating from the light source 126 of the mobile device 130, for example flash LED, thereby spreading the light over the test device.

The diffusers 116A, 116B may be attached to, affixed to, and/or embedded within the respective transparent windows 114A, 114B. In some embodiments, the diffusers 116A, 116B may be cast in the respective windows 114A, 114B as a single component, which may include a plastic material. As a nonlimiting example, the windows 114A, 114B may be cast in a transparent plastic and include a Fresnel lens cast in the plastic as the respective diffuser 116A, 116B. The diffuser 116A and/or 116B may have a surface area of about 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, or 2.0 cm² or more, or any value or range defined by any of the preceding values. In some embodiments, the diffuser 116A and/or 116B may have a surface area of about 0.5 cm² to about 1 cm², though in some embodiments the diffuser may have a surface area outside this range. The area of the diffuser 116A and/or 116B may be large enough to capture all, substantially all, or at least a portion of the light emitted by the mobile device light source 126. The diffuser 116A and/or 116B may be rectangular, circular, or elliptical in shape. In some embodiments, the windows 114A 114B may include a plurality of respective diffusers 116A, 116B. For example, where a box 100 is usable with a mobile device 130A having two or more light sources 126, the window 114A may include two or more diffusers 116A, each of the two or more diffusers 116A corresponding to one of the light sources 126.

In some embodiments, the location of the windows 114A, 114B and diffusers 116A, 116B on the box 100 can be specific to a model of mobile device, e.g. mobile device, and/or to a group of models of mobile device having similar camera and/or light source configurations. For example, window 114A and diffuser 116A may be specific to mobile device 130A, while window 114B and diffuser 116B may be specific to mobile device 130B. Though FIGS. 1A-1B depicts two windows 114A and 114B, the box may include 1, 2, 3, 4, 5, 6, 7, 8, 9, 10, or more windows. Each window may include one or more diffusers. It will also be understood that, in some non-limiting implementations, a window 114 does not include a diffuser 116.

The mobile device placement markings 106A and 106B on the upper surface 104 of the box 100 can direct a user to align the mobile devices 130A, 130B with the light box 100 such that the mobile device's camera 128 is aligned with the respective transparent window 114A, 114B. The mobile device placement markings 106A and 106B on the upper surface 104 of the box 100 can direct a user to align the mobile device with the light box 100 such that the mobile device's light source 126 is aligned with the respective diffuser 116A, 116B. Such mobile device placement markings 106A, 106B may include, for example, an outline indicative of the location where the mobile device 130A, 130B should be placed. In some embodiments, the upper surface 104 may be recessed from a top surface of the box 100. The top surface may be positioned further from the test device 202 than the upper surface 104. The recessing of the upper surface 104 from the top surface can assist a user in positioning the mobile device 130. In some embodiments, the top surface may be formed by a layer of material positioned over and attached to the upper surface 104. In such embodiments, the top surface may include a cutout region defining the recessing between the top surface and the upper surface 104.

The window 114A and diffuser 116A may be covered with and/or overlayed by a perforated and removable cover 108A of the box 100, which may incorporate a pull-tab 110A for easy identification and removal. The window 114B and diffuser 116B may be covered with and/or overlayed by a perforated and removable cover 108B of the box 100, which may incorporate a pull-tab 110B for easy identification and removal. A user may remove the removable covers 108A, 108B from the box 100 by tearing along the perforated edges of the removable covers 108A, 108B. The pull-tabs 110A, 110B may fold upward, providing the user with surfaces to grip when attempting to remove the removable covers 108A, 108B, respectively. The perforated and removable cover 108A of the box 100 may serve to protect the window 114A and/or the diffuser 116A prior to imaging of the test device. The perforated and removable cover 108B of the box 100 may serve to protect the window 114B and/or the diffuser 116B prior to imaging of the test device. The perforated and removable cover 108A of the box 100 may serve to protect the window 114A and diffuser 116A during shipping of the box 100 and/or the test device 202. The perforated and removable cover 108B of the box 100 may serve to protect the window 114B and diffuser 116B during shipping of the box 100 and/or the test device 202.

With continued reference to FIGS. 1A-2, inclusion of a low-profile light diffuser 116A and/or 116B may be desirable for use with a mobile device light source 126, such as a flash LED. As discussed herein, the diffuser 116A and/or 116B may be capable of spreading light across a test device 202, thereby preventing glare in an image taken by the camera 128 and/or uneven distribution of light on the test device 202. Many different materials may be suitable for inclusion in the diffuser 116A and/or 116B, such as fiber/paper or plastics, especially low-cost plastics. In some embodiments, the diffuser 116A and/or 116B may include a lens, for example a Fresnel lens, a regularly spaced lens, or a randomly spaced lens. In some embodiments, the diffuser 116A and/or 116B may include one or more etched surfaces. For example, the diffuser 116A and/or 116B may include etched plastic or etched glass. Lenses and/or etched surfaces may all be implemented in low-cost and thin plastic, depending on the extent of diffusion and light transmission desired within the box structure 102 and the particular light source 126. In some embodiments, fiber-based (e.g., rice paper) could be included in the diffuser 116A and/or 116B.

As shown in FIG. 2, to ensure adequate focal distance between the mobile device's camera 128 and the bottom interior surface of the box structure 102, where the test device 202 will be placed on the test cartridge carriage 120, the height h of the box structure 102 may be matched to either a specific mobile device model or a generic distance that allows for cameras of one or more models of mobile device to focus on the test device 202. Additionally, when window 114 and alignment markings 124A, 124B (FIG. 1E) are used, the height h, in combination with a position of the window 114 and the diffuser 116 relative to the test device alignment markings 124A, 124B (FIG. 1E), may ensure that the test device 202 is within the camera field 206 and the region of diffuse light 208. To reliably image the correct region of the test device 202, a test cartridge carriage 120 (also referred to herein as “carriage”) is included within the box 100.

As shown in FIG. 1E, the test cartridge carriage 120 can direct a user to properly place the test device 202 by means of mobile device model-specific test device alignment markings 124A and 124B. The test cartridge carriage 120 can be removed from the box 100, allowing the user to identify the correct test device alignment markings 124A or 124B and attach the test device 202, for example by placing the test device 202 on adhesive pad 122A or 122B, respectively. In some embodiments, the carriage 120 can substantially immobilize the test device 202 by positioning the test device on an adhesive pad 122A or 122B included on the test cartridge carriage 120. As an illustrative example, the adhesive pad 122A and/or 122B may include a double-sided adhesive strip. The adhesive pad 122A and/or 122B can prevent or inhibit movement of the test device 202 relative to the test cartridge carriage 120 as the test cartridge carriage 120 is inserted back into the box structure 102, or in the event of movement of the box 100 while the test device 202 and the carriage 120 are within the box structure 102.

The carriage 120 can include printed markings in addition to alignment markers described herein. The carriage 120 may or may not incorporate features of a scan card. The carriage 120 can be a scan card having printed markings. The printed marking can be used during analysis of a test device placed on the scan card and/or analysis of an image of the test device and the scan card. The printed markings can include, but are not limited to, printed reference colors, control markings, boundaries of an image region, fiducials, and other features. The printed markings can be used to analyze a result of a test performed on the test device and/or adequacy of lighting, orientation, and focus conditions associated with an image of the test device. The following applications discuss non-limiting examples of scan cards that can be implemented in accordance with the present disclosure: U.S. application Ser. No. 17/098,236, entitled DIAGNOSTIC TEST KITS FOR SAMPLE PREPARATION AND ANALYSIS, U.S. application Ser. No. 17/222,819, entitled DIAGNOSTIC TEST KITS AND METHODS OF ANALYZING THE SAME, U.S. application Ser. No. 29/812,505, entitled SCAN CARD FOR IN VITRO ASSAY, and U.S. application Ser. No. 29/816,279, entitled SCAN CARD FOR IN VITRO ASSAY, each of which is incorporated by reference herein in its entirety.

Overall alignment between the window 114A and/or 114B and the test device 202 may be defined in part by the size of the carriage 120 relative to the box 100. The carriage 120 can be sized to fit within the box 100, with the closeness of the fit defining the stack-up tolerances between the test device 202 and the mobile device 130. The closer the fit, the smaller a gap 204 between the carriage 120 and the interior sides of the box structure 102 will be. A loose fit (e.g., where gap 204 is relatively large) between the carriage 120 and the box structure 102 may cause less precise alignment of the carriage 120 within the box within an acceptable tolerance. Removal and insertion of the carriage 120 may be easier with a loose fit between the carriage 120 and box structure 102.

Optical component alignment can be maintained at least in part by the dimensions and rigidity of the box 100 and the inclusion of fiducial markers on the test device 202 and/or the carriage 120. In other words, the alignment of the mobile device's camera 128 and LED light source 126, the diffuser 116A and/or 116B, and the test device 202 can be maintained at least in part by the dimensions and rigidity of the box 100 and the use of fiducial markers on the test device 202. The carriage 120 may also assist in maintaining alignment.

In some embodiments, the box structure 102 and/or the carriage 120 includes cardboard, a low-cost and high strength-to-weight material commonly used in consumer packaging. In some embodiments, the cardboard may be corrugated, if relatively high strength is desired. In some embodiments, the cardboard may not be corrugated.

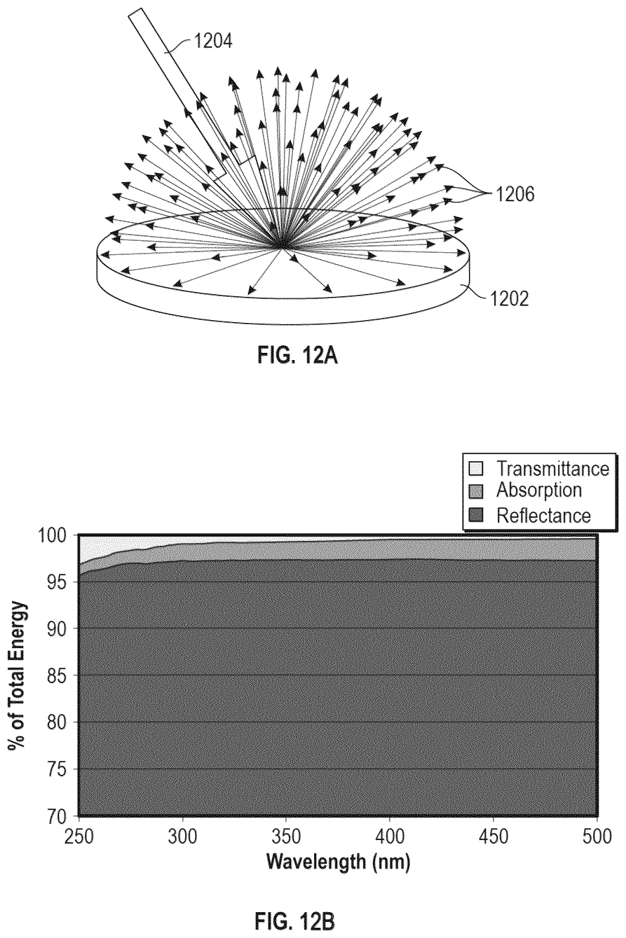

The interior surface of the box structure 102 can be coated in or include a material to improve and/or optimize light conditions such as reflected light brightness and/or homogeneity of illumination. Surface reflectivity and color can be primary variables to consider. For example, a reflective coating may maximize internal ambient brightness. As another example, a light matte coating could optimize internal homogeneity of illumination. Sintered PTFE, discussed below with reference to FIGS. 12-15C, is an example material that, when included with the box structure 102, may help increase or maximize internal homogeneity of illumination as well as yielding high levels of internal ambient brightness.

In some examples, a kit includes a test device 202 (which can include a diagnostic assay) and a light box 100. The kit may also include instructions for use, including instructions for use of the test device 202 and/or instructions for use of the light box 100 with the test device 202 and a mobile device to produce a suitable image.

### Adapting the Lightbox to Different Models of Mobile Device

Certain properties of the box 100 may be specific to each model of mobile device 130. For example, specific dimensions and/or configurations of the box may correspond to one or more different mobile device models, for example mobile device 130A or mobile device 130B. The overall length and width of the box structure 102 to support the mobile device 130A and/or 130B may be specific to a mobile device model. The positioning of the transparent window 114A and the light diffuser 116A can match the mobile device's camera configuration and may be specific to a first mobile device model. The positioning of the transparent window 114B and the light diffuser 116B can match the mobile device 130B's camera configuration and may be specific to a second mobile device model. The first mobile device model may be different than the second mobile device model. As discussed above, the box structure 102 may include a transparent window 114A protected by a removable cover 108A and/or a transparent window 114B protected by a removable cover 108B. In the embodiment depicted in FIG. 1, a user may choose to remove removable cover 108A or 108B depending on the model of mobile device or set of models of mobile device to be used with the box 100. In some embodiments, each of windows 114A and 114B may be suitably used for several different models of mobile device with similarly located cameras. In such embodiments, there may be tolerances in the size and/or positioning of the windows 114A, 114B and diffusers 116A, 116B such that more than one model of mobile device can be accommodated. In one example, it may be desirable to remove only removable cover 108A corresponding to the mobile device 130A, so as to prevent external light from transmitting to the interior of the box structure 102 via the removable cover 108B that is not used. In another example, it may be desirable to remove only removable cover 108B corresponding to the mobile device 130B, so as to prevent external light from transmitting to the interior of the box structure 102 via the removable cover 108A that is not used. The location of test device alignment markings 124A and adhesive pads 122A on the test carriage to match the mobile device configuration may be specific to a mobile device model or set of mobile device models. The location of test device alignment markings 124B and adhesive pads 122B on the test carriage to match the mobile device configuration may be specific to a mobile device model or set of mobile device models. Such test device alignment markings 124A and/or 124B may include, for example, an outline indicative of the location of where the test device 202 should be placed. The box height h to match an ideal focal distance of the mobile device camera 128 may be specific to a mobile device model. For several models of mobile device, a minimum focal distance may be about 15 cm to generate a focused image, so the box height h may be about 15 cm or more in some embodiments. In some embodiments, the box 100 may be at least partially foldable or unfoldable from a shipping configuration, in which the box 100 has a first height suitable for enclosing a test device 202 and any other kit components such as instructions, swabs, or the like, and an imaging configuration, in which the box 100 has a second height h greater than the first height, with the second height h corresponding to a desired focal distance for imaging the test device 202. In some embodiments, the box 100 may be at least partially foldable or unfoldable from a shipping configuration, in which the box 100 is folded flat, and an imaging configuration, in which the box 100 has a second height h greater than the first height, with the second height h corresponding to a desired focal distance for imaging the diagnostic test device 202. The box 100 may have adjustable dimensions to accommodate various different models of mobile device. For example, the box may have heights h₁, h₂, h₃, . . . hₙ, each height h₁ through hₙ corresponding to a focal distance of a model or sets of models of mobile device.

The above-mentioned parameters may be unique to a specific mobile device model, for example a specific model of phone. Thus, in some embodiments, a specific disposable packaging/light box configuration may correspond to each mobile device model. That is to say, a unique box configuration uniquely corresponds to each mobile device model. In some embodiments, such as the one depicted in FIGS. 1A-1E, a box configuration may correspond to two or more mobile device models. In such embodiments, the overall footprint of the disposable packaging/light box may be identical across many models of mobile device, with the mobile device placement markings 106A, 106B and imaging aperture 118A, 118B location altered. In some embodiments, a plurality of mobile device placement markings 106A, 106B and imaging windows 114A, 114B can be incorporated into a single package, as shown in FIGS. 1A-1E. This can allow more than one mobile device to be supported by a single box configuration.

### Detection of Fluorescence Signals From a Test Device

Though the box 100 has been described primarily in the context of colorimetric and reflectometric assay modes, the box 100 could be used to permit signals from other kinds of assays. In one non-limiting example, the box 100 can permit detection of fluorescence signals, through incorporation of the correct excitation and emission filters into the diffuser and imaging window. In such an embodiment, the diffuser 116A and/or 116B may include an excitation filter that can permit passage of light of a wavelength or a range of wavelengths that can excite a fluorophore of the test device 202. Excitation light may thereby be transmitted from the mobile device light source 126 through the diffuser 116A and/or 116B including an excitation filter to the test device 202. The window 114A and/or 114B may include an emission filter that can permit passage of light of a wavelength or a range of wavelengths that are emitted by the fluorophore of the test device 202. Light emitted by the fluorophore may thereby be transmitted through the window 114A and/or 114B to the mobile device camera 128.

### Light Box for Test Device With Integrated Light Source

In some embodiments, light boxes of the present disclosure may include a light source such as, for example, a composite light source in a configuration that casts relatively uniform and/or homogeneous light over the top surface of a test device (such as but not limited to a diagnostic assay) and a background area. In some embodiments, the composite light source includes a plurality of light-emitting diodes (LEDs) or other light emitters. The plurality of LEDs can include one or more sets of LEDs. The plurality of LEDs can be included in one or more strips of LEDs. The enclosure may be a box with one or more downward-facing and/or downward-angled strips of LED lights included on the interior top surface of the box. The box may include an aperture at the top allowing for a camera to image the surface, for example the top surface of a test device, at the bottom of the box. The aperture may be sized and shaped to receive a mobile device, for example a mobile device.

### Overview of the Light Box With Integrated Light Source

Homogeneous and bright lighting, as can be provided by integrated compound light sources, may improve sensitivity of point-of-care assay reading. Such point-of-care assays can include lateral flow immunoassays or colorimetric assays. For lateral flow immunoassays, bright uniform light may help increase the contrast between the test line and background portions surrounding the test line. Uniform lighting may also facilitate accurate analysis and/or segmentation of diagnostic test images by preventing shadows in captured images. FIGS. 3-5 illustrate example light box systems 300 with light sources included with a box 302. The box 302 may be usable with a range of test devices (including many types of diagnostic assays).

In some examples, a kit includes a test device 202 (such as but not limited to a diagnostic assay), and a light box 302 with included lights. In some non-limiting examples, the kit may also include a custom mobile device 306 installed with instructions for use. The mobile device 306 can include a camera configured to capture an image, and a processor comprising a memory storing instructions to process the image. A user may install the custom mobile device in a fixed position relative to the box prior to imaging the test device, or the custom mobile device may be pre-installed in the fixed position relative to the box. In some embodiments, the box may include an aperture specific to fit to a particular mobile device. An aperture in a light box 302 is obscured by a mobile device 306 in the example illustrated in FIG. 3, while an aperture 402 is illustrated in a light box 402 in the example illustrated in FIG. 5. The aperture may be specific to the custom mobile device included in the kit. In some embodiments, the upper surface of the box may be recessed, creating a depression sized to fit the custom mobile device. In some embodiments, the aperture 402 is provided within the depression. In some embodiments, the custom mobile device may be an original equipment manufacturer (“OEM”) smartphone. In some embodiments, the custom mobile device may be pre-loaded with software for analyzing an image, such as an image captured using the light box, and displaying a test result based at least in part on the image. In some embodiments, the custom mobile device having the pre-loaded software may be capable of determining a result of the diagnostic assay (or other test device) based at least in part on an image captured using the light box.

FIG. 3 illustrates an example box including an aperture for a mobile device. The box may include one or more insertion ports 308 for a variety of test devices, including a diagnostic assay housed in a cassette. For example, one or more insertion ports 308 may be shaped and sized to receive a test assay cassette, a urinalysis dipstick, and/or a colorimetric blood analysis strip. The insertion port(s) 308 may be sized such that, when a test assay cassette is inserted, substantially no light or minimal light from outside the box can be transmitted to the interior of the box through the insertion port(s) 308. The insertion port(s) 308 may be sized such that, when a test device, for example a test assay cassette 310, a urinalysis dipstick 312, and/or a colorimetric blood analysis strip, is inserted, a portion of the test device remains outside the box such that a user can grip and/or remove the test device when imaging has concluded. The recessed opening 314 may be sized and shaped to accept a mobile device 306. The recessed opening 314 may be positioned to align the mobile device with an aperture that can allow the mobile device to image test devices positioned within the box 302. In some embodiments, the box does not include a recessed opening, and the mobile device can be placed on a flat top surface of the box 302 that includes the aperture 402.

The box 302 may include a power cord 304 and/or may include an internal power source such as a battery. The power cord 304 may be configured to power the plurality of light sources within the box 302, for example the one or more sets of LEDs. The battery may be configured to power the plurality of light sources within the box, for example the one or more sets of LEDs. The battery may be a single-use battery (e.g., not rechargeable and/or disposable) or a rechargeable battery. In certain embodiments where the battery is rechargeable, the box 302 may include a power cord or port capable of connecting to an electrical outlet, thereby charging the battery. In certain embodiments where the battery is rechargeable, the battery may be removed from the box to recharge.

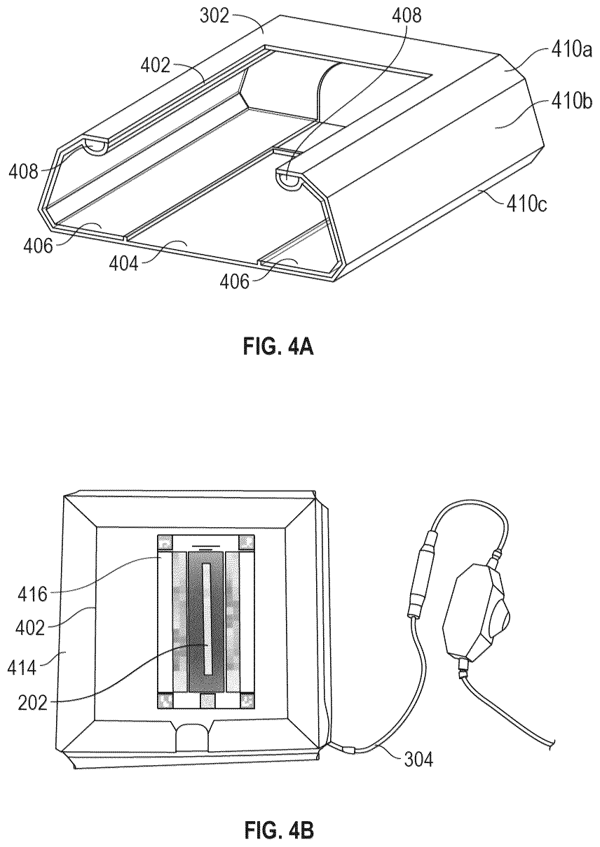

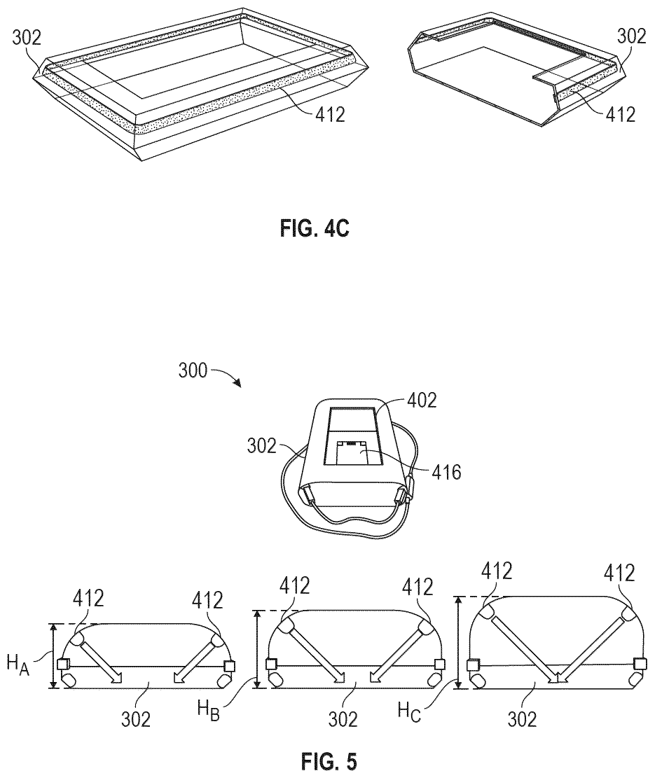

FIGS. 4A-4B illustrate light boxes 302 and 414 that includes an aperture 402 that may be compatible with many and/or all mobile devices, including many and/or all mobile phones. In some embodiments, the box 302 may include a plastic, for example white nylon, thermoplastic resin. In some embodiments, the box 302 may include a paper and/or a cardboard. In some embodiments, such as those depicted in FIGS. 4B, 8, 9, 11A-11F, and 15, the outer surfaces of the box 302 or 414 may be rectangular and/or flat. In some embodiments, such as those depicted in FIG. 5, some of the outer surfaces of the box 302 may be curved. In some embodiments, such as those depicted in FIGS. 4A and 4C, the outer surfaces of the box may be trapezoidal. In such embodiments, the sides of the box 302 may include more than one surface, for example surfaces 410a, 410b, and 410c. The interior walls of the box 302 may optionally include reflective and/or light-scattering materials. For example, the interior walls of the box 302 or 414 may include high-gloss white nylon, thermoplastic resin, and/or porous polytetrafluoroethylene (“PTFE”). It may be desirable that the interior surface of the box 302 is matte, such that light reflected off the surface is scattered and/or diffuse. The box may optionally include a diffuser. The diffuser may ensure uniformity of lighting within the box. The diffuser may include a frosted plastic. The light sources within the box can provide uniform lighting and may be used with a method that eliminates the need for factory calibration of the light sources. For example, the lighting provided by the light sources may be sufficiently consistent that image processing by the mobile device obviates the need for a factory calibration of the light sources.

FIG. 4A illustrates an example light box 302 that includes indentations or protrusions that can hold a diagnostic test kit. In some embodiments, the light box may include indentations or protrusions to aid in positioning and/or holding a diagnostic test kit. An indentation 404 may act as a holder of a diagnostic test kit on a bottom surface 406 of the box 302. In implementations including an insertion port, the indentations and/or protrusions may align with the insertion port. In some embodiments, the indentations and/or protrusions may be sized to accept the diagnostic test kit and hold the diagnostic test kit within an imaging region within the box. In some embodiments, the box may include markings to guide user placement of the diagnostic test kit within the box. Such markings may include, for example, an outline on the bottom interior surface of the box indicative of the location where the diagnostic test kit should be placed. In some embodiments, for example the embodiment depicted in FIG. 4B, the box may be capable of accepting a scan card 416. The scan card 416 can include printed markings. The printed marking can be used during analysis of a test device placed on the scan card and/or analysis of an image of the test device and the scan card. The printed markings can include, but are not limited to, printed reference colors, control markings, boundaries of an image region, and other features. The printed markings can be used to analyze a result of a test performed on the test device and/or adequacy of lighting, orientation, and focus conditions associated with an image of the test device. The scan card 416 may or may not include features of a carriage. For instance, the scan card 416 may or may not include markings and/or adhesive patches for alignment and placement of a test device 202. In some embodiments, the bottom surface 406 (including all or portions of indentation 404) can be a scan card. Markings can be pre-printed on the bottom interior surface during manufacture of the box 302. In such an example, a user may be instructed to place a test device 202 on a test placement guide provided on (for example, printed on) the bottom interior surface of the box 302. The test placement guide can be an alignment marking identifying a location for placement of the test device on the scan card. In such an example, a carriage may not be implemented.

FIG. 4C illustrates a box 302 that includes a plurality of light sources. It will be understood that embodiments of light boxes according to the present disclosure can include any suitable light source, such as, but not exclusively, sets of LEDs. The sets of LEDs may include LED strips. FIG. 4C indicates the positioning of the plurality of light sources 412, for example LED strips, within the box 302 for some embodiments. The plurality of light sources 412 may be positioned at upper interior portion of the walls of the box 302.

In some embodiments, the box 302 may include a diffuser between the light source and the test device, such as test device 202. The diffuser may include a translucent or semi-translucent material, for example frosted plastic, fiber/paper (e.g., rice paper), plastic having an etched surface, glass having an etched surface, lenses, in particular Fresnel lenses, regularly spaced lenses, or randomly spaced lenses. The diffuser may position or secure the light sources to point them at an angle relative to a location where the test device may be placed, for example an indentation 404. In some embodiments, the box 302 can be used with a mobile device 130, for example a smartphone or a tablet, as the camera. In some embodiments, an aperture 402 at the top of the light box may facilitate use of the light box with a wide range of mobile devices. In some embodiments, the aperture 402 at the top of the light box may be specific to a particular type of mobile device (e.g., a particular model or a set of particular models of mobile device). In some embodiments, the aperture 402 at the top of the light box may accept an adaptor, where the adaptor is specific to a particular model or models of mobile device and can fit within the aperture 402. In embodiments where a mobile device is used to image the test device, the box 302 may include mobile device placement markings to indicate to a user where the mobile device should be placed for imaging. Such markings may include, for example, an outline on the exterior surface of the box indicative of the location where the mobile device should be placed. In some embodiments, the box includes a dedicated camera installed in a fixed position relative to the box.

The box 302 may include a component for securing the plurality of light sources 412 within the interior of the box 302. The component may be capable of securing the light sources 412 at a particular angle, such that light is sufficiently transmitted to the location of the diagnostic test device during imaging. The component may secure the plurality of light sources 412 at an angle relative to vertical. In some embodiments, the box 302 may include a component, for example element 408 illustrated in FIG. 4A, for securing the plurality of light sources, for example one or more LED strips, in place within the interior of the box 302. The component may secure the plurality of light sources 412, for example one or more LED strips, at an angle relative to vertical. In some embodiments, the element 408 can act as a diffuser for the plurality of light sources 412. In such embodiments, the element 408 may be translucent or semi-translucent. In such embodiments, the element 408 may include a frosted plastic. In some alternative embodiments, the element 408 is not a diffuser but is opaque. In such embodiments, the element 408 may be a bracket that can secure the plurality of light sources 412 while minimally, or substantially not, interfering with transmission of light from the plurality of light sources.

FIG. 5 illustrates a light box 302 with integrated light sources 412 including sets of LEDs. The sets of LEDs may face downward at an angle between 15° and 85°, relative to vertical. In some embodiments, the sets of LEDs may be angled at 45° relative to vertical, as shown in FIG. 5. FIG. 5 also displays three different embodiments where the sets of LEDs are positioned at different heights due to different box heights. The heights H include height H_{A}, height H_{B} which is 0.5 inches greater than H_{A}, or H_{C} which is 1 inch greater than H_{A}. The height H of the box may affect the illumination of the test device 202 when positioned within the box 302. The height H of the box 302 may match and/or exceed an ideal focal distance of the mobile device camera 128. The height H may be specific to a mobile device model. For several models of mobile device, a minimum focal distance may be about 15 cm to generate a focused image, so the box height H of box 302 may be about 15 cm or more in some embodiments.

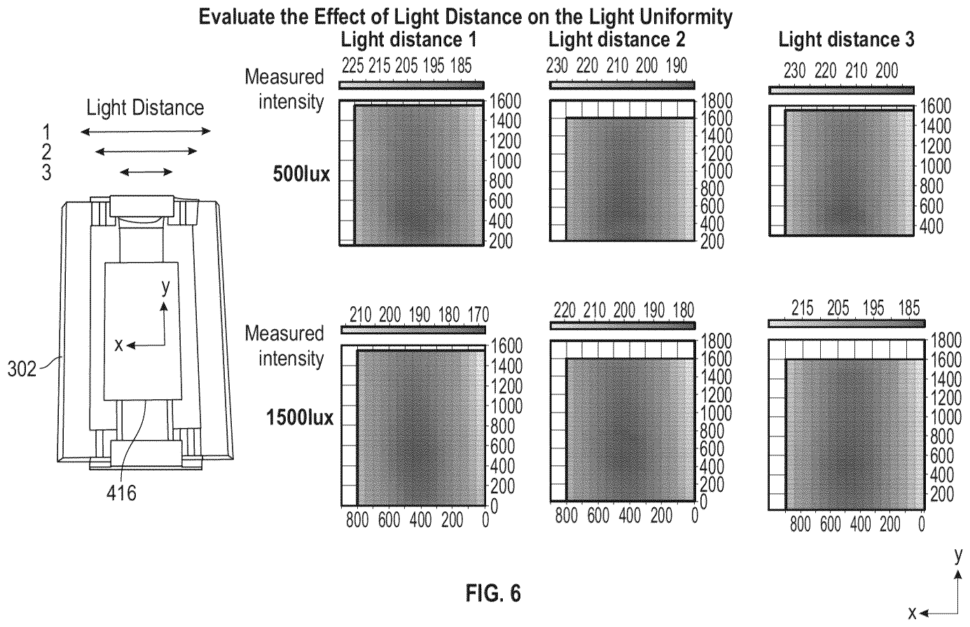

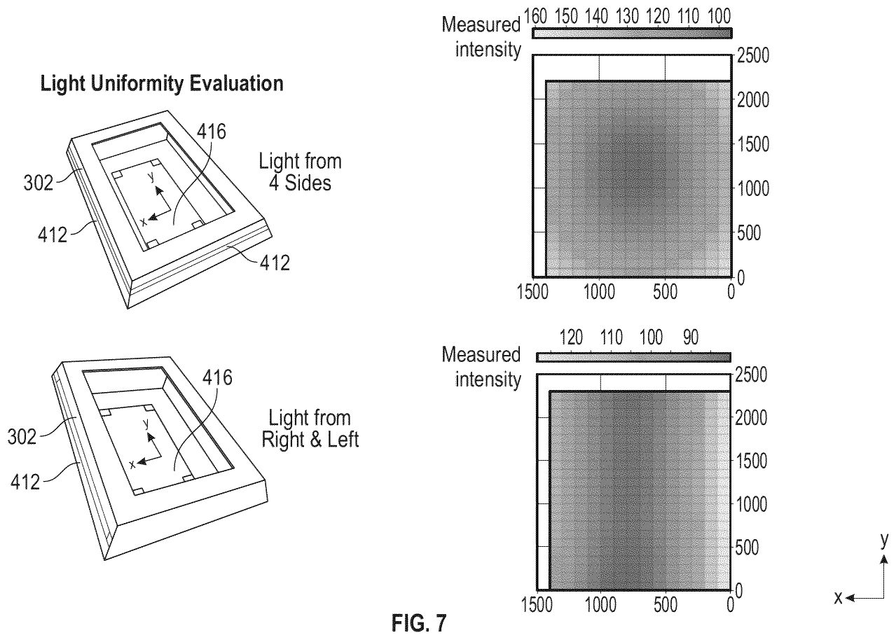

FIG. 6 plots light intensity measurements across the bottom surface of the box for three different horizontal distances 1, 2, and 3, between the sets of LEDs positioned about the center of the bottom surface of the box. The x and y axes of the plots in FIG. 6 correspond to pixel positions within an acquired image. The LEDs were either 500 lux or 1500 lux, as indicated. FIG. 7 shows light intensity measurements for a configuration having four sets of LEDs on each interior wall of the box, as well as light intensity measurements for a configuration having sets of LEDs on only two opposite walls of the interior of the box. The x and y axes of the plots in FIG. 7 correspond to pixel positions within an acquired image. The light source may be angled relative to vertical, for example at 45° relative to vertical. For example, the example light box illustrated in FIG. 3 can include two sets of LEDs that are angled at a 45° angle relative to vertical.

In some embodiments, the box includes a tray capable of diffusing light (that is, acting as a diffuser) emitted by the plurality of light sources (e.g., two or more sets of LEDs), thereby creating diffuse lighting conditions for the test device. The tray may be positioned between the plurality of light sources and the test device. The tray may include a frosted plastic.

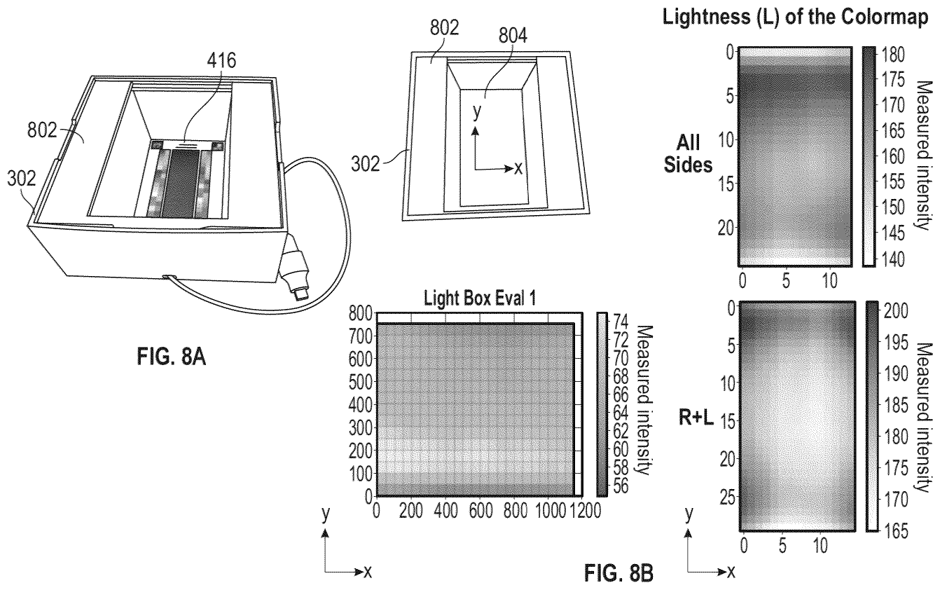

FIGS. 8A and 9-10 illustrate a light box 302 that can include a tray 802 that can diffuse light. Referring specifically to FIG. 8A, in some embodiments, the box may include a 3D-printed and/or thermoformed tray 802 as a diffuser for the light sources 412 included in the box 302 When the thermoformed tray 802 is inserted into the box 302 as depicted in FIG. 8A, the light source 412 may be covered such that light must pass through the thermoformed tray 802 before arriving at test device 202. As shown in FIG. 8B, the inclusion of light sources on four sides may provide more uniform illumination relative to a light box with light sources on two sides. FIG. 9 depicts a light box 302 which does not include a thermoformed tray. As shown in FIG. 9, the light source 412 may be attached to the interior walls of box 302. FIG. 10 shows an exemplary tray 802, which can be inserted within a light box 302. The tray 802 may include a test device placement area 804. The test device 202 can be placed on the test device placement area 804. The scan card 416 can be placed on the test device placement area 804, where a test device 202 can be placed on the scan card 416. The test device placement area 804 may include markings for aligning the test device and/or imaging as discussed herein with reference to a bottom surface of the box 302.

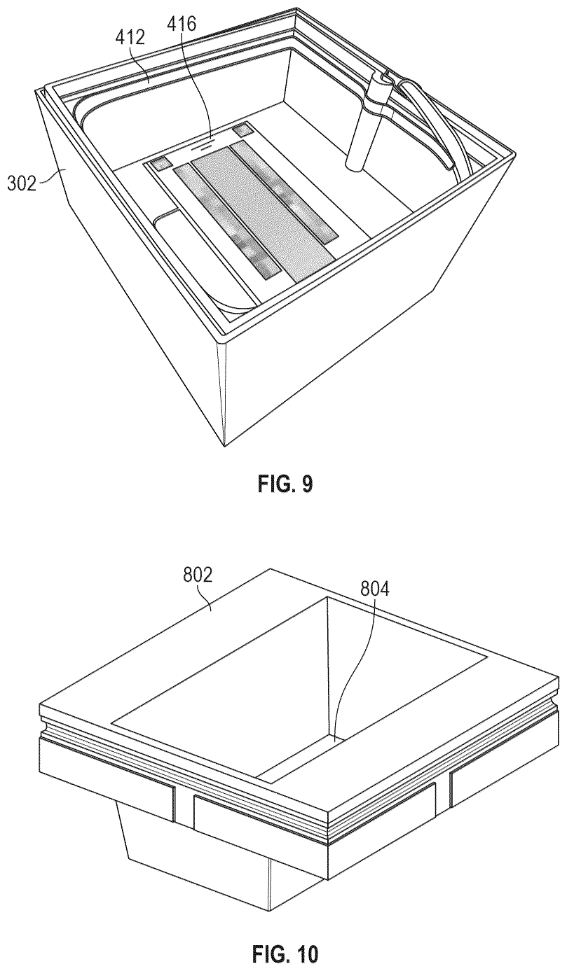

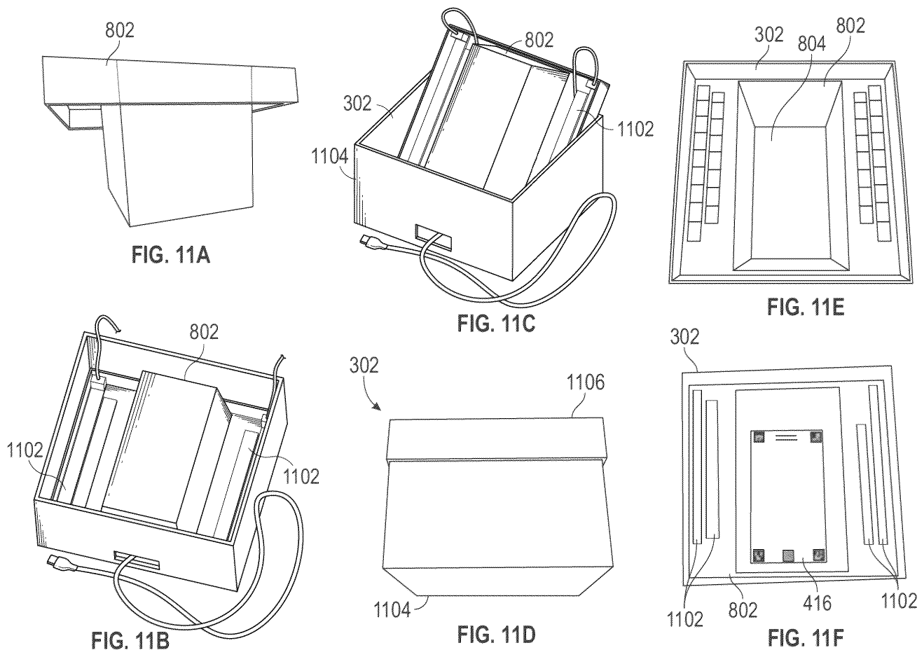

FIGS. 11A-11F depict the tray 802 alone and inserted within a box 302. FIG. 11A illustrates a side view of the tray 802. FIG. 11B illustrates a bottom view of the tray 802. FIG. 11C illustrates a bottom view of the tray 802 received in the box 302 in an orientation to show features at the bottom of the tray 802. FIG. 11D illustrates a side view of the box 302 including a base 1104 and a lid 1106. FIG. 11E illustrates a top view of the tray 802 positioned in the box 302. FIG. 11F illustrates a top view of the tray 802 positioned in the box 302 with a scan card 416 positioned within the tray 802. A test device 202 can be received on the scan card 416 positioned within the tray 802. The tray 802 may include a transparent or semi-transparent material that can diffuse light. At least a portion of the tray 802 may be positioned between the plurality of light sources, here LED strips 1102, and the test device 202 as shown in FIG. 11F. The LED strips 1102 may be positioned on and/or attached to the tray 802. The LED strips 1102 may be positioned on and/or attached to an underside of the tray 802. FIGS. 11B and 11C illustrate such an attachment of the LED strips 1102 to the tray 802. The LED strips 1102 may be positioned on the tray 802 such that, when the tray 802 is positioned within the box 302, as depicted in FIGS. 11E and 11F, the LEDs 1102 are positioned near the upper corners of the interior of the box 302.

In embodiments including both a tray 802 and an insertion port, the tray 802 may include a loading aperture to allow for the test device to be inserted into the tray 802 via the insertion port from the exterior of the box 302. When the tray 802 is inserted in the box 302, the loading aperture may align with the insertion port. The loading aperture may be sized and shaped to allow passage of the test device while minimizing the transmission of non-diffuse light through the loading aperture. In some examples, the loading aperture may be sized and shaped about as large as the profile cross-section of the test device, with a gap about the test device as it is loaded of less than or up to 0.5, 1, 1.5, 2, 2.5 3, 3.5 4, 4.5, or 5 mm or more, or any value within a range defined by any two of the preceding values.

FIG. 11D illustrates a side view of the box 302 including a base 1104 and a lid 1106. The lid 1106 may include an imaging aperture that can allow the mobile device to image the test device 202. The lid 1106 may be removable. The lid 1106 may be removed to facilitate placement of the tray 802 and/or the test device 202.

In some embodiments where the plurality of light sources 412 include sets of LEDs, there may be at least 2, at least 4, at least 8, at least 10, at least 16, at least 20, at least 24, and/or at least 30 LEDs within the box. It will be understood that other numbers of LEDs can be suitably implemented. The sets of LEDs may include LEDs spaced apart from each other by about 0.1, 0.2, 0.3, 0.4, 0.5, 1, 1.5, 2.0, 2.5, 3.0, 3.5, 4.0, 4.5, 5.0, 5.5, 6.0, 6.5, 7.0, 7.5, 8.0, 8.5, 9.0, 9.5, 10, 11, 12, 13, 14, 15, 16, 17, 18, 19, or 20 cm or more, or any value within a range defined by any two of the preceding values, though in some embodiments other spacings may be used. In some embodiments, the LEDs are spaced at least about 1 cm from each other. The total number of LEDs, the spacing of the LEDs, the intensity of the LEDs, and the size and/or shape of the box 302 may all be chosen so that the illumination within the box 302 is suitably bright and diffuse during imaging. The size of the test assay cartridge may also be a consideration when choosing the total number of LED lights, the LED light intensity, the spacing of the LED lights, and the size of the box. Other types of light sources, in addition to or instead of LED light sources, can also be suitably implemented in light boxes according to the present disclosure.

Some embodiments include differential lighting provided by multiple alternate lighting sources, such as different sets of LEDs. Each lighting source, for example each set of LEDs, can be set to emit a certain wavelength and/or range of wavelengths to optimize a readout of diagnostic tests. The emitted wavelengths and/or ranges of wavelength of the lighting sources may be different. As a nonlimiting example, a plurality of LED lights may be configured to provide white light, while another plurality of LED lights may be configured to provide light in a narrower range of frequencies, of visible or nonvisible light. These alternate lighting sources may be used to enhance the contrast or emission of conjugate materials used in next-generation diagnostic assays.

### Fluorescent Image Detection

Though the box 302 has been described primarily in the context of colorimetric and reflectometric assay modes, the box 302 could be used to permit fluorescent image detection, through incorporation of the correct excitation and emission filters. In some such embodiments, the diffusing tray 802 may include an excitation filter that can permit passage of light of a wavelength or a range of wavelengths that can excite a fluorophore of the test device. In some such embodiments, the plurality of light sources 412 may be capable of emitting light at an excitation wavelength but not at an emission wavelength. In either case, excitation light may thereby be transmitted from the plurality of light sources to the test device. The aperture 402 may include an emission filter that can permit passage of light of a wavelength or a range of wavelengths that are emitted by the fluorophore of the test device. The light emitted by the fluorophore may thereby be transmitted through the emission filter to the mobile device camera.

### Sintered Optical Components in Diagnostic Testing Hardware

As described above, it may be desirable in various embodiments to improve the uniformity or homogeneity of illumination light within the light box. Accordingly, aspects of the present disclosure relate to materials such as sintered polymers for inclusion in light boxes in accordance with the present disclosure. In some embodiments, sintered polymers may be used within the disclosed light boxes, for example, as a lining, coating, and/or interior surface of a light box. Sintered polymers, more specifically sintered polymer-based reflectors present another technology platform with many attractive features for use in diagnostic test hardware.

Lambertian surfaces may have almost constant reflection of light regardless of incident light angle. FIG. 12A schematically illustrates this phenomenon, where the angles of reflecting beams 1206 from a Lambertian reflector 1202 are independent on the angle of the incident light beam 1204. Sintered polytetrafluoroethylene (“PTFE”)-based reflectors are an example Lambertian reflector. Some such materials have almost constant reflection over a wide wavelength range, e.g., of 250-2500 nm, or from ultraviolet (UV) to mid-infrared (MIR). In the spectral range of 300-1500 nm, such materials may achieve a reflection value of up to 99%. In some embodiments, sintered PTFE's high reflectivity may obviate the need for a diffuser between a light source of a light box and the imaged surface.

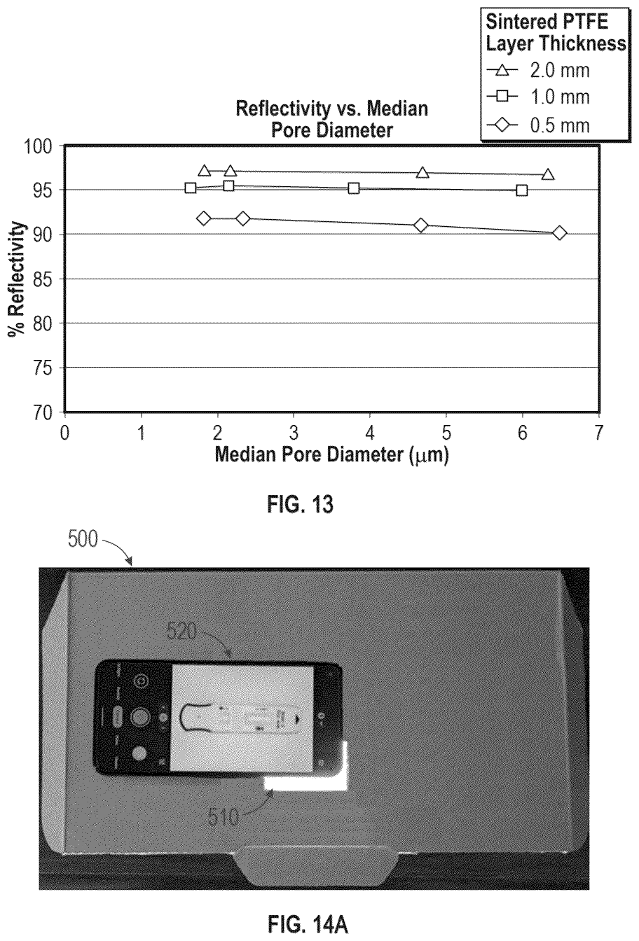

A sintered PTFE coating may have several properties making it useful for coating an inside of a light box of the present disclosure. A sintered PTFE polymer reflector has almost constant transmittance and absorbance from about 275 nm to about 500 nm as shown in FIG. 12B. Also, a proportion of light reflected may be independent of PTFE layer thickness. For a given layer thickness, sintered PTFE polymer reflectance does not substantially change as a function of median pore diameter over the range of about 2 μm to 6 μm, as plotted in FIG. 13.

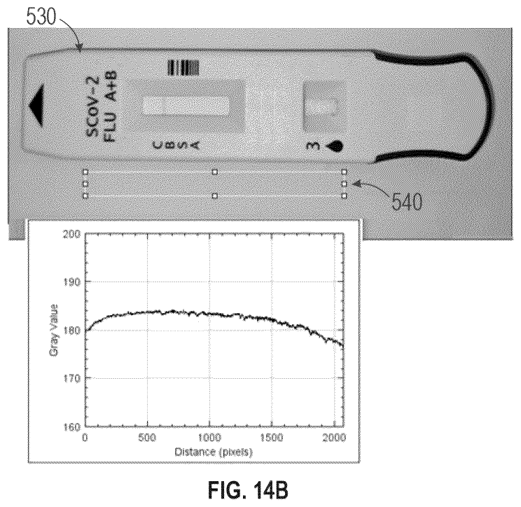

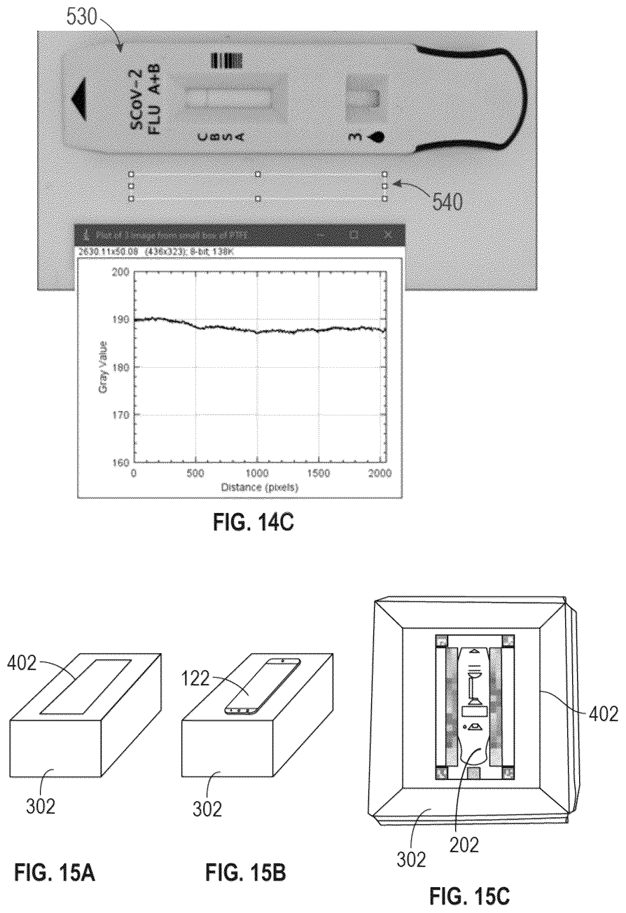

Results from one run of imaging experiments are presented in FIGS. 14A-14C to show the impact of sintered PTFE in application for improving the illumination uniformity inside a light box in accordance with embodiments of the present disclosure. FIG. 14A illustrates a top view of a light box 500 made from cardboard of a brown color. It has a dimension of ˜315 mm by 180 mm by 125 mm with the opening window 510 of 50 mm by 30 mm on the top surface, where a smartphone 520 is placed which has: a camera lens of F/1.7, 12.2 M pixels and a built-in white LED. The focusing distance set in the light box 500 for imaging by the smartphone 520 is about ˜120 mm over a FOV of ˜103 mm by 77 mm.

The imaging experiments consists of two phases. During Phase 1, the internal surfaces of the light box 500 are all covered by white paper cut from standard A4 printer paper. One image captured by the smartphone with auto-exposure control during LED flash illumination is shown in FIG. 14B, where a test cartridge 530 of a length of ˜96 mm is centered within the imaging FOV, and the selected area of interest 540 for illumination analysis, from which averaged profile of illumination along the horizontal direction is calculated and plotted below the selected area. As shown in FIG. 14B, the illumination within the FOV is relatively nonuniform, since the profile of illumination along the horizontal direction is not flat, but curved.

During Phase 2, the internal surfaces of the light box 500 are all covered by sintered PTFE cut from sheets of 0.5 mm (3M 300LSE). With all other conditions for imaging being the same, one image captured by the smartphone with auto-exposure control during LED flash illumination is shown in FIG. 14C, where the same test cartridge 530 is centered within the imaging FOV, and similarly the selected area of interest for illumination analysis is denoted as 540, from which averaged profile of illumination along the horizontal direction is calculated and plotted below the selected area. As shown in FIG. 14C, the illumination within the FOV not only becomes more uniform, but also ˜5% higher in illumination intensity with a sintered PTFE material coating the internal surfaces of the light box 500.

The PTFE-based sintered reflector material may be used with the various embodiments of light boxes disclosed herein to improve image generation of various test devices. For example, the PTFE-based sintered reflector material may be used with an at-home test that uses a mobile device, for example a smartphone camera and an app, to capture and interpret results, eliminating the human subjectivity in other visually read at-home diagnostic tests. Porous PTFE (for example, porous Teflon®) is an example sintered polymer material that can be suitably implemented in light boxes according to the present disclosure. Further, PTFE is resistant to oxidation which can ensure that it will not yellow or discolor with shelf life.

An example test for use with a light box including sintered PTFE is the urine Albumin to Creatinine Ratio (ACR) test. The ACR test utilizes the printed reference colors on the cartridge/image to perform a color correction. The ground truth color information (gtXYZ) of the printed reference colors can be established using a densitometer at the D65 illumination setting. Test images captured under different illumination conditions may exhibit larger biases of the test result after the color correction process. It has also been observed that there is uneven lighting on the cartridge when there are shadows or uneven lighting conditions. Factors such as uneven illumination, shadows, and glare can impact the color correction process. Also, a higher variance in the albumin and creatinine readings can be observed under soft light or fluorescent light conditions. Such conditions may lead to error messages for end-users, stating that the captured image is unreadable. This can create end-user frustration and inhibit widespread adoption of point-of-care tests, for example the ACR test.

### Overview of Sintered Optical Components Used With Light Boxes

A PTFE-based sintered reflector may be included within boxes (e.g., light boxes) in accordance with the present disclosure. FIGS. 15A and 15B illustrate the exterior of such a light box. FIG. 15C illustrates a view through the aperture of such a box, after an insert or carriage (for example but not limited to a scan card 416) and a test device 202 have been received in the box. A PTFE-based sintered reflector layer may improve light distribution uniformity in any kind of light box. Embodiments of a light box with a PTFE-based sintered reflector can include light boxes including built-in light sources and/or imaging devices in accordance with the present disclosure. Embodiments can include a light box that is a disposable box that can function as packaging, in accordance with the present disclosure.

In some embodiments, at least one internal surface of the box includes a layer of sintered PTFE polymer. In some embodiments, some or all internal surfaces of the box, such as the bottom, the side, and/or top surfaces of the interior of the box, include a layer of sintered PTFE polymer. In some embodiments, an insert or cartridge carriage with a sintered PTFE polymer may be included with the light box. In one example, a user removes the scan card 416 from the box 302, positions a test cartridge on the scan card 416, and re-inserts the scan card 416 with the test cartridge into the box for analysis. In some embodiments, the box including a sintered PTFE polymer layer may include one or two open ends. The PTFE layer may be a thin layer, a film, or the like. A suitable layer thickness for sintered PTFE range may be between 0.2 mm to 2.0 mm, 0.5 to 1.0 mm, and/or less than 0.5 mm, though other ranges or values may be suitable. In certain embodiments, a range of suitable sintered PTFE layer thicknesses can be 0.2 mm to 1.0 mm. When a light source is used, for example a mobile device's flash LED or internal light source provided within the light box, a homogeneous and consistent lighting condition is provided on the printed reference colors of the carriage (if printed reference colors are included on the carriage for colorimetric tests), as well as for cartridge imaging. The PTFE-based sintered reflector material may thereby help improve cartridge images obtained for diagnostic testing.

Light boxes incorporating a PTFE-based sintered reflector according to the present disclosure can advantageously implement a packaging configuration having a reduced profile or volume, while maintaining improved light distribution in an assembled-for-use configuration. In one non-limiting example, a kit includes a light box in the form of a flat-fold box. The light box can include any of the features described herein, including but not limited to a window for image capture and alignment markings. The kit can optionally include a test carriage and a test device (for example a diagnostic test, such as an assay test strip). The test carriage and the test device can be packaged inside the flat-fold box or packaged with the flat-fold box. In one non-limiting example, the kit includes a mobile device configured to image and interpret the diagnostic test. The kit can also include instructions for a user to assemble the flat-fold box from a flat packaging configuration to a three-dimensional assembled configuration by popping the box up into a 3-, 4-, 5-, or 6-sided box at pre-creased folds. The flat-fold box may include pre-placed adhesives to secure the box in the three-dimensional assembled configuration. In the flat packaging configuration, the flat-fold box can be very compact for shipping, storage, and display. In the three-dimensional assembled configuration, the flat-fold box can have a height optimized to generate a focused image using a wide variety of mobile devices, such as but not limited to a height of 15 cm. In one non-limiting example, the flat-fold box transforms to a 4-sided box that is open on two ends. Interior surfaces of the box can be coated with a PTFE-based sintered reflector that can optimize light distribution within the light box, as described above. Embodiments of light boxes that can be shipped in a flat configuration and assembled at the point of use into a box having optimal height and light distribution properties can advantageously reduce manufacturing, shipping, and storage costs.

### Terminology

Unless defined otherwise, all technical and scientific terms used herein have the same meaning as is commonly understood by one of ordinary skill in the art. The use of the term “including” as well as other forms, such as “include,” “includes,” and “included,” is not limiting. The use of the term “having” as well as other forms, such as “have,” “has,” and “had,” is not limiting. The terms “comprising,” “including,” “having,” and the like are synonymous and are used inclusively, in an open-ended fashion, and do not exclude additional elements, features, acts, operations, and so forth. That is, the above terms are to be interpreted synonymously with the phrases “having at least” or “including at least.” For example, when used in the context of a process, the term “comprising” means that the process includes at least the recited steps, but may include additional steps. When used in the context of a device, the term “comprising” means that the device includes at least the recited features or components, but may also include additional features or components. Also, the term “or” is used in its inclusive sense (and not in its exclusive sense) so that when used, for example, to connect a list of elements, the term “or” means one, some, or all of the elements in the list. Further, the term “each,” as used herein, in addition to having its ordinary meaning, can mean any subset of a set of elements to which the term “each” is applied.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

The term “and/or” as used herein has its broadest least-limiting meaning which is the disclosure includes A alone, B alone, both A and B together, or A or B alternatively, but does not require both A and B or require one of A or one of B. As used herein, the phrase “at least one of” A, B, “and” C should be construed to mean a logical A or B or C, using a non-exclusive logical or.

Conditional language used herein, such as, among others, “can,” “could,” “might,” “may,” and the like, unless specifically stated otherwise, or otherwise understood within the context as used, is generally intended to convey that certain features, elements and/or steps are optional. Thus, such conditional language is not generally intended to imply that features, elements and/or steps are in any way required. The terms “comprising,” “including,” “having,” and the like are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Any methods disclosed herein need not be performed in the order recited. The methods disclosed herein include certain actions taken by a practitioner; however, they can also include any third-party instruction of those actions, either expressly or by implication.

Some or all of the methods and tasks described herein may be performed and fully automated by a computer system. A diagnostic test system according to the present disclosure can include a computer system that may, in some cases, include multiple distinct computers or computing devices (for example, physical servers, workstations, storage arrays, cloud computing resources, etc.) that communicate and interoperate over a network to perform the described functions. Each such computing device typically includes a processor (or multiple processors) that executes program instructions or modules stored in a memory or other non-transitory computer-readable storage medium or device (for example, solid state storage devices, disk drives, etc.). The various functions disclosed herein may be embodied in such program instructions, and/or may be implemented in application-specific circuitry (for example, ASICs or FPGAs) of the computer system. Where the computer system includes multiple computing devices, these devices may, but need not, be co-located. The results of the disclosed methods and tasks may be persistently stored by transforming physical storage devices, such as solid-state memory chips and/or magnetic disks, into a different state. The computer system may be a cloud-based computing system whose processing resources are shared by multiple distinct business entities or other users.

While the above detailed description has shown, described, and pointed out novel features, it can be understood that various omissions, substitutions, and changes in the form and details of the devices, systems, and methods can be made without departing from the spirit of the present disclosure. As can be recognized, certain portions of the description herein can be embodied within a form that does not provide all of the features and benefits set forth herein, as some features can be used or practiced separately from others. Consequently, it is not intended that the present disclosure be limited to the specific embodiments disclosed herein, but that it covers all modifications and alternatives coming within the true scope and spirit of the present disclosure.

1-32. (canceled)

33. A light box for imaging a diagnostic test device, the light box comprising:
a box structure, the box structure configured to unfold from a shipping configuration to an imaging configuration for use with the diagnostic test device, the box structure comprising:
a plurality of side walls and an upper surface defining an interior volume; and
at least one aperture in the upper surface configured to allow a mobile device to image the diagnostic test device through the aperture while the diagnostic test device is disposed within the interior volume.

34. The light box of claim 33, further comprising a carriage sized and shaped to fit within the interior volume of the light box and configured to facilitate positioning of the diagnostic test device within the light box for imaging by the mobile device.

35. The light box of claim 34, wherein the carriage comprises an adhesive configured to secure the diagnostic test device to the carriage.

36. The light box of claim 34, wherein the carriage comprises at least one alignment marking identifying a location for placement of the diagnostic test device on the carriage.

37. The light box of claim 33, wherein the at least one aperture comprises a transparent window and wherein the mobile device at least partially rests on the transparent window.

38. The light box of claim 33, wherein the upper surface is configured to support the mobile device while the mobile device images the diagnostic test device through the aperture.

39. The light box of claim 33, further comprising a polytetrafluoroethylene (PTFE) polymer coating on at least one interior surface of the box structure.

40. The light box of claim 33, wherein the at least one aperture is sized and shaped to simultaneously accommodate image capture by a camera of the mobile device and illumination of the diagnostic test device by a light emitter of the mobile device.

41. The light box of claim 33, wherein the at least one aperture comprises a first aperture sized and shaped to accommodate simultaneous illumination and imaging of the diagnostic test device by a first model of mobile device having a first camera and flash configuration, and a second aperture sized and shaped to accommodate simultaneous illumination and imaging of the diagnostic test device by a second model of mobile device having a second camera and flash configuration.

42. The light box of claim 33, wherein the upper surface comprises at least one alignment marking identifying a location for placement of the mobile device on the upper surface.

43. The light box of claim 33, further comprising a light diffuser positioned above or below the aperture.

44. The light box of claim 43, wherein the light diffuser is affixed to a bottom surface of a transparent window at least partially covering the aperture.

45. The light box of claim 33, further comprising a removable protective covering overlying at least a portion of the aperture.

46. The light box of claim 33, wherein the shipping configuration has a first height and the imaging configuration having a second height greater than the first height, the second height corresponding to an imaging focal distance of the mobile device.

47. The light box of claim 33, wherein the upper surface is recessed from a top surface of the box structure, the upper surface configured to receive and hold the mobile device.

48. The light box of claim 33, wherein the box structure is reusable.

49. The light box of claim 33, wherein the box structure is disposable.

50. The light box of claim 33, further comprising the diagnostic test device disposed within the interior volume.

51. The light box of claim 33, wherein the light box is a shipping container for the diagnostic test device.

52. A method of imaging a test device, comprising:
unfolding a light box from a shipping configuration to an imaging configuration, wherein the light box comprises an aperture;
placing a test device within the light box in the imaging configuration; and
imaging, using a mobile device, the test device.

53. The method of claim 52, further comprising removing a cover from the aperture of the light box.

54. The method of claim 52, further comprising aligning a camera of the mobile device with the aperture.

55. The method of claim 52, further comprising aligning the test device with the aperture.

56. The method of claim 52, further comprising placing the mobile device on a surface of the light box.

57. The method of claim 52, wherein placing the test device within the light box comprises placing the test device on a carriage and inserting the carriage into the light box.

58. The method of claim 57, further comprising adhering the test device to the carriage.

59. The method of claim 52, wherein, in the imaging configuration, the light box has a height greater than or equal to a focal distance of the mobile device.

60. The method of claim 52, wherein the box structure is reusable, and the method further comprises reusing the light box.

61. The method of claim 52, wherein the box structure is disposable, and the method further comprises disposing of the light box.

62. The method of claim 52, wherein the diagnostic test device is disposed within the interior volume in the shipping configuration.

63. The method of claim 52, wherein the light box is a shipping container for the diagnostic test device.
